(19) United States
(12) Patent Application Publication
(10) Pub. No.: US 2004/0036959 A1
(43) Pub. Date: Feb. 26, 2004

(54) Optical transmission system employing erbium-doped optical amplifiers and Raman amplifiers

(76) Inventors: Stephen G. Evangelides JR., Red Bank, NJ (US); Jonathan A. Nagel, Brooklyn, NY (US); Mark K. Young, Monmouth Junction, NJ (US)

Correspondence Address: MAYER, FORTKORT & WILLIAMS, PC, 251 NORTH AVENUE WEST, 2ND FLOOR, WESTFIELD, NJ, 07090, US

(21) Appl. No.: 10/313,965

(22) Filed: Dec. 6, 2002

Related U.S. Application Data
(60) Provisional application No. 60/404,610, filed on Aug. 20, 2002.

(51) Int. Cl. H04B 10/12

(52) U.S. Cl. 359/341.5

(57) ABSTRACT

In an optical communication system that includes a transmitting terminal, a receiving terminal, and an optical transmission path optically coupling the transmitting and receiving terminals and having at least one rare-earth doped optical amplifier therein, a second optical amplifier is provided The second optical amplifier includes a first portion of the optical transmission path having a first end coupled to the transmitting terminal and a second end coupled to a first of the rare-earth doped optical amplifiers. In addition, the second optical amplifier includes a pump source providing pump energy to the first portion of the optical transmission path at one or more wavelengths that is less than a signal wavelength to provide Raman gain in the first portion at the signal wavelength.

### STATEMENT OF RELATED APPLICATION

This application claims the benefit of priority of U.S. Provisional Patent Application No. 60/404,610 filed Aug. 20, 2002, entitled “Hybrid Raman/EDFA Undersea Transmission System”

### FIELD OF THE INVENTION

The present invention relates generally to optical transmission systems, and more particularly to an undersea optical transmission system that employs Raman amplifiers.

### BACKGROUND OF THE INVENTION

An undersea optical transmission system consists of land-based terminals interconnected by a cable that is installed on the ocean floor. The cable contains optical fibers that carry Dense Wavelength Division Multiplexed (DWDM) optical signals between the terminals. The land-based terminals contain power supplies for the undersea cable, transmission equipment to insert and remove DWDM signals from the fibers and associated monitoring and control equipment. Over long distances the strength and quality of a transmitted optical signal diminishes. Accordingly, repeaters are located along the cable, which contain optical amplifiers to provide amplification to the optical signals to overcome fiber loss. The optical amplifiers that are employed are generally erbium-doped fiber amplifiers. In some cases the optical amplifiers are Raman amplifiers that are used by themselves or in conjunction with erbium-doped fiber amplifiers. When erbium-doped fiber amplifiers are employed, the repeater spacing is typically in the range of about 50-80 km, so that the first repeater must be installed about 50-80 km from the shore.

A typical undersea route followed by an optical cable first traverses the relatively shallow continental shelf seafloor as it exits the transmitting terminal before entering deeper water. The cable once again traverses shallower water as it approaches the land-based receiving terminal. The repeaters located near the shore are generally buried in the seabed. Most cable failures arising in such transmission systems generally occur in the shallow portions of the seafloor as a result of fishing activity and impacts with anchors from ships. Such failures often require the replacement of damaged repeaters, which can be an unduly expensive and time-consuming proposition, particularly since they must be dug up from the seabed.

Accordingly, it would be desirable to provide an undersea optical transmission system having as few repeaters as possible located in the shallow waters near the land-based terminals.

### SUMMARY OF THE INVENTION

In an optical communication system that includes a transmitting terminal, a receiving terminal, and an optical transmission path optically coupling the transmitting and receiving terminals and having at least one rare-earth doped optical amplifier therein, the present invention provides a second optical amplifier. The second optical amplifier includes a first portion of the optical transmission path having a first end coupled to the transmitting terminal and a second end coupled to a first of the rare-earth doped optical amplifiers. In addition, the second optical amplifier includes a pump source providing pump energy to the first portion of the optical transmission path at one or more wavelengths that is less than a signal wavelength to provide Raman gain in the first portion at the signal wavelength.

In accordance with one aspect of the invention, a third optical amplifier is provided. The third optical amplifier includes a second portion of the optical transmission path having a first end coupled to the receiving terminal and a second end coupled to one of the rare-earth doped optical amplifiers. A second pump source provides pump energy to the second portion of the optical transmission path at one or more wavelengths less than a signal wavelength to provide Raman gain in the second portion at the signal wavelength.

In accordance with another aspect of the invention, the pump source provides Raman gain having a gain profile over a signal waveband with a positive gain tilt.

In accordance with yet another aspect of the invention, the Raman gain is less than that required to supply a signal saturating the first rare-earth doped optical amplifier.

In accordance with another aspect of the invention, a plurality of rare-earth doped optical amplifiers are provided that are spaced apart from one another along the transmission path by a given distance. The given distance is less than a length of the first portion of the transmission path in which Raman gain is provided.

In accordance with another aspect of the invention, a method is provided for transmitting an information-bearing optical signal along an optical communication system. The communication system includes a transmitting terminal, a receiving terminal, and an optical transmission path optically coupling the transmitting and receiving terminals and having at least one rare-earth doped optical amplifier therein. The method begins by receiving the information-bearing optical signal from the transmitting terminal and supplying Raman gain to the optical signal in a first portion of the optical transmission path. Subsequently, the optical signal is forwarded to a first of the rare-earth doped optical amplifiers.

In an optical communication system that includes a transmitting terminal, a receiving terminal, and an optical transmission path optically coupling the transmitting and receiving terminals and having a plurality of optical amplifiers spaced apart from one another along the transmission path by a given distance, the present invention provides a Raman optical amplifier. The Raman optical amplifier includes a first portion of the optical transmission path having a first end coupled to the transmitting terminal and a second end coupled to a first of the plurality of optical amplifiers. A pump source provides pump energy to the first portion of the optical transmission path at one or more wavelengths less than a signal wavelength to provide Raman gain in the first portion at the signal wavelength. The given distance is less than a length of the first portion of the transmission path in which Raman gain is provided.

### BRIEF DESCRIPTIONS OF THE INVENTION

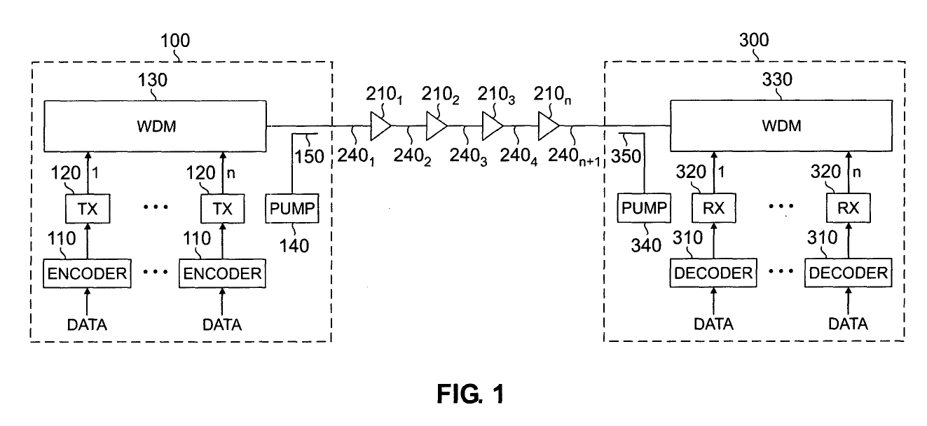

FIG. 1 shows a simplified block diagram of an exemplary wavelength division multiplexed (WDM) transmission system in accordance with the present invention.

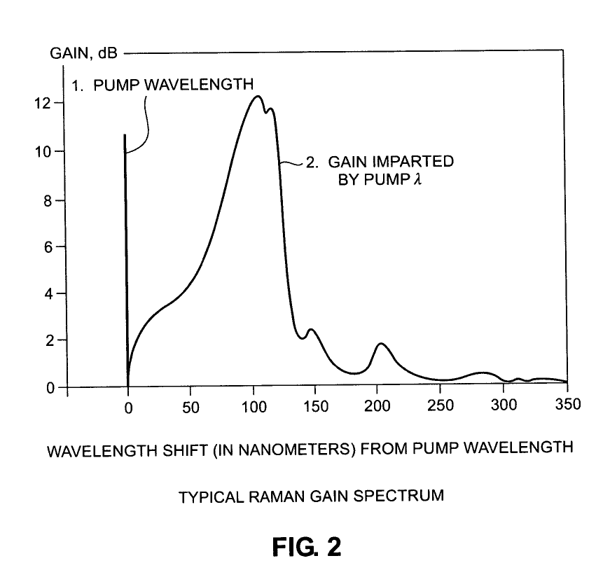

FIG. 2 shows the relationship between the pump energy and the Raman gain for a silica fiber.

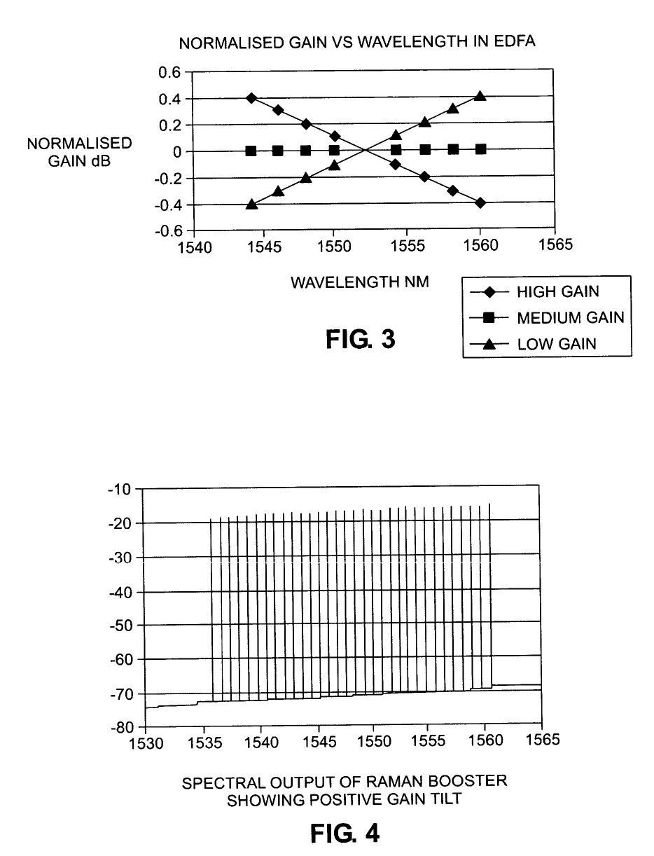

FIG. 3 shows a graph of the normalized gain of an erbium-doped optical amplifier as a function of input signal over a wavelength range of 1544 nm to 1560 nm.

FIG. 4 shows the spectral output from a typical Raman booster amplifier designed to have negative slope.

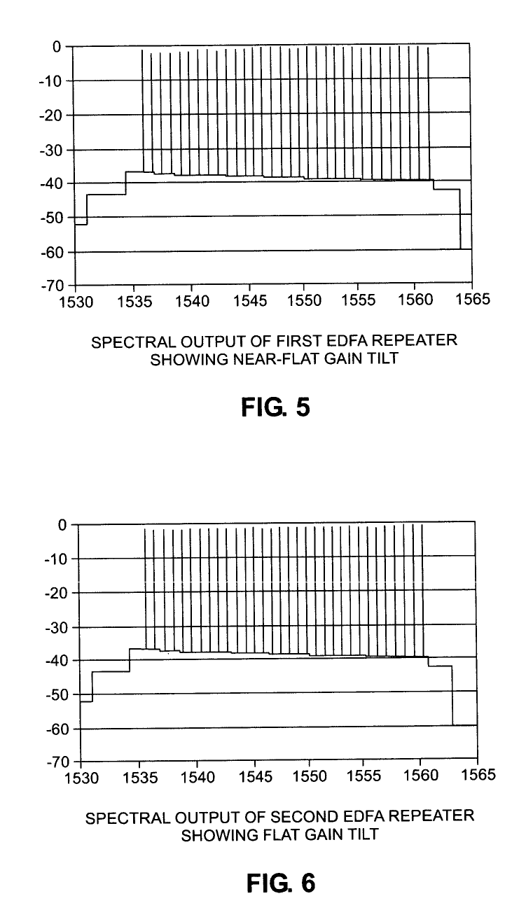

FIG. 5 shows the spectral output from the first erbium-doped optical amplifier, which has as its input the output signal from the Raman amplifier depicted in FIG. 4.

FIG. 6 shows the spectral output from the second erbium-doped optical amplifier, which has as its input the output signal from the first erbium-doped optical amplifier depicted in FIG. 5.

### DETAILED DESCRIPTION OF THE INVENTION

FIG. 1 shows a simplified block diagram of an exemplary wavelength division multiplexed (WDM) transmission system in accordance with the present invention. The transmission system serves to transmit a plurality of optical channels over a single path from a transmitting terminal to a remotely located receiving terminal. While FIG. 1 depicts a unidirectional transmission system, it should be noted that if a bi-directional communication system is to be employed, two distinct transmission paths are used to carry the bi-directional communication. The optical transmission system may be an undersea transmission system in which the terminals are located on shore and one or more repeaters may be located underwater

Transmitter terminal 100 is connected to an optical transmission medium 200, which is connected, in turn, to receiver terminal 300. Transmitter terminal 100 includes a series of encoders 110 and digital transmitters 120 connected to a wavelength division multiplexer 130. For each WDM channel, an encoder 110 is connected to a digital transmitter 120, which, in turn, is connected to the wavelength division multiplexer 130. In other words, wavelength division multiplexer 130 receives signals associated with multiple WDM channels, each of which has an associated digital transmitter 120 and encoder 110. Transmitter terminal 100 also includes a pump source 140 that supplies pump energy to the transmission medium 200 via a coupler 150. As discussed in more detail below, the pump energy serves to generate Raman gain in the transmission medium 200.

Digital transmitter 120 can be any type of system component that converts electrical signals to optical signals. For example, digital transmitter 120 can include an optical source such as a semiconductor laser or a light-emitting diode, which can be modulated directly by, for example, varying the injection current. WDM multiplexer 130 can be any type of device that combines signals from multiple WDM channels. For example, WDM multiplexer 130 can be a star coupler, a fiber Fabry-Perot filter, an inline Bragg grating, a diffraction grating, cascaded filters and a wavelength grating router, among others.

Receiver terminal 300 includes a series of decoders 310, digital receivers 320 and a wavelength division demultiplexer 330. WDM demultiplexer 330 can be any type of device that separates signals from multiple WDM channels. For example, WDM demultiplexer 330 can be a star coupler, a fiber Fabry-Perot filter, an in-line Bragg grating, a diffraction grating, cascaded filters and a wavelength grating router, among others. Receiver terminal 300 also includes a pump source 340 that supplies pump energy to the transmission medium 200 via a coupler 350 to generate Raman gain.

Optical transmission medium 200 includes rare-earth doped optical amplifiers 210₁-210ₙ interconnected by transmission spans 240₁-240ₙ₊₁ of optical fiber, for example. If a bi-directional communication system is to be employed, rare-earth doped optical amplifiers are provided in each transmission path. Moreover, in a bi-directional system each of the terminals 100 and 300 include a transmitter and a receiver. In a bi-directional undersea communication system a pair of rare-earth doped optical amplifiers supporting opposite-traveling signals is often housed in a single unit known as a repeater. While only four rare-earth optical amplifiers are depicted in FIG. 1 for clarity of discussion, it should be understood by those skilled in the art that the present invention finds application in transmission paths of all lengths having many additional (or fewer) sets of such amplifiers.

In accordance with the present invention, transmission spans 240₁ and 240ₙ₊₁ nearest terminals 100 and 300, respectively, serve as the gain medium for Raman amplifiers. In effect, transmission span 240₁ serves as a booster amplifier while the transmission span 240ₙ₊₁ serves as a preamplifier to receiver terminal 300. The optical amplifiers 210₁-210ₙ, located between transmission spans 240₁ and 240ₙ₊₁ along transmission medium 200, are rare-earth doped optical amplifiers such as erbium doped optical amplifiers. One important advantage arising from this arrangement is that the rare-earth doped optical amplifiers 210₁ and 210ₙ nearest terminals 100 and 300, respectively, can be located father from shore than would otherwise be possible if Raman gain were not supplied to transmission spans 240₁ and 240ₙ₊₁. For example, in a conventional undersea transmission system employing rare-earth doped optical amplifiers exclusively, the spacing between amplifiers or repeaters is typically in the range of 50-80 km and the amplifiers are designed for a gain consistent with span losses in the range of 10-14 dB. In contrast, rare-earth doped optical amplifiers 210₁ and 210ₙ can be located about 125-150 km from their respective terminals 100 and 300, which corresponds to span losses in the range of 25-30 dB. The distance between the rare-earth doped optical amplifiers 210₂-210ₙ remains at about 50-80 km. Since rare-earth doped optical amplifiers 210₁ and 210ₙ can be located farther offshore, fewer repeaters are required in the relatively shallow seafloor nearest the land-based terminals, which is the region in which the amplifiers are most likely to be damaged. Accordingly, system reliability can be significantly enhanced.

In some embodiments of the invention the distances between adjacent rare-earth doped optical amplifiers 210₂-210ₙ₋₁ are not constant. In these embodiments the respective distances between the rare-earth doped optical amplifiers 210₁ and 210ₙ and the terminals 100 and 300 may be greater than the average distance between adjacent rare-earth doped optical amplifiers 210₂-210ₙ₋₁. Alternatively, the distance between the rare-earth doped optical amplifiers 210₁ and 210ₙ and the terminals 100 and 300 may be greater than a majority of the individual distances between rare-earth doped optical amplifiers 210₂-210ₙ₋₁.

Another important advantage of the present invention arises when there is a cable cut, which, as previously mentioned, is most likely to occur in the transmission span near the shore. When the cable is repaired, it is typically necessary to add additional cable, which adds additional loss to the transmission span being repaired. Because Raman gain is being supplied to this transmission span by the booster amplifier, the extra loss can be readily compensated by increasing the Raman pump power to thereby increase the Raman gain.

Raman amplifiers use stimulated Raman scattering to amplify an incoming information-bearing optical signal. Stimulated Raman scattering occurs in silica fibers (and other materials) when an intense pump beam propagates through it. Stimulated Raman scattering is an inelastic scattering process in which an incident pump photon looses its energy to create another photon of reduced energy at a lower frequency. The remaining energy is absorbed by the fiber medium in the form of molecular vibrations (i.e., optical phonons). That is, pump energy of a given wavelength amplifies a signal at a longer wavelength. The relationship between the pump energy and the Raman gain for a silica fiber is shown in FIG. 2. The particular wavelength of the pump energy that is used in this example is denoted by reference numeral 1. As shown, the effective Raman gain occurs about 75 to 125 nm from the pump signal. The separation between the pump wavelength and the wavelength at which Raman gain is imparted is referred to as the Stokes shift. For silica fiber, the peak Stokes shift is about 100 nm.

By using multiple pump wavelengths the Raman amplifier can amplify a relatively broad band of signal wavelengths. That is, varying the spectral shape of the pump energy can readily control the magnitude and gain shape of a Raman amplifier. For example, multiple pump wavelengths can be used to reduce gain variations over the signal bandwidth, thereby providing an amplifier with a flat gain shape. Alternatively, multiple pump wavelengths with a different spectral shape can be used to impart a gain tilt or slope to the signal bandwidth. If the gain increases with increasing signal wavelength the gain tilt is said to have a positive slope. If the gain decreases with increasing signal wavelength the gain tilt is said to have a negative slope.

As seen in FIG. 1, the pump source 140 supplying Raman gain to transmission span 240₁ is located in transmitter terminal 100 and thus the pump energy co-propagates with the signal. That is, the Raman booster amplifier is forward pumped. On the other hand, the pump source 340 supplying Raman gain to transmission span 210n+1 is located in receiver terminal 300 and thus the pump energy counter-propagates with the signal. That is, the Raman preamplifier is backward pumped.

The rare-earth doped optical amplifiers 210₁-210ₙ provide optical gain to overcome attenuation in the transmission path. Each rare-earth doped optical amplifier contains a length of doped fiber that provides a gain medium, an energy source that pumps the doped fiber to provide gain, and a means of coupling the pump energy into the doped fiber without interfering with the signal being amplified. The rare-earth element with which the fiber is doped is typically erbium. The gain tilt of an erbium-doped fiber amplifier is in large part determined by its gain level. FIG. 3 shows a graph of the normalized gain of an EDFA as a function of input signal over a wavelength range of 1544 nm to 1560 nm. At a relatively low gain (corresponding to a saturated EDFA), the gain tilt is positive, whereas at a high value of gain (corresponding to an unsaturated EDFA), the gain tilt is negative.

In optically amplified WDM communications systems, to achieve acceptable signal-to-noise ratios (SNR) for all WDM channels it is necessary to have a constant value of gain for all channel wavelengths. This is known as gain flatness and is defined as a low or zero value of the rate of change of gain with respect to wavelength at a fixed input level. Unequal gain distribution adversely affects the quality of the multiplexed optical signal, particularly in long-haul systems where insufficient gain leads to large signal-to-noise ratio degradations and too much gain can cause nonlinearity induced penalties. Conventional erbium-doped optical amplifiers achieve gain flatness by careful design of the erbium doped fiber amplifiers and with the use of gain flattening filters.

One advantage arising from the use of a booster amplifier supplying gain to transmission span 240, is that gain flatness can be readily achieved. This is accomplished by selecting a gain shape for the booster amplifier that has a positive gain tilt. As previously mentioned, this can be accomplished in a well-known manner by selecting an appropriate spectral shape for the pump energy supplied to transmission span 240₁. On the other hand, the first erbium-doped optical amplifier 210₁ located downstream from the booster amplifier will have a negative gain tilt that can be used to counter-balance the positive gain tilt of the booster Raman amplifier to thereby provide an overall flat gain. The gain tilt of erbium doped optical amplifier 210₁ will be negative because the booster amplifier, operating in saturation, will not have sufficient gain to raise the signal level to the design point of the first erbium-doped optical amplifier. Since the input signal level to erbium-doped optical amplifier 210₁ is below its design point, the amplifier 210₂ will not be saturated. As discussed above in connection with FIG. 3, an unsaturated, high gain erbium-doped optical amplifier has a negative gain tilt. Moreover, as the signal continues to propagate along the transmission medium 200 subsequent erbium-doped optical amplifiers 210₂-210ₙ will restore the signal level to its design point as a result of the well-known self-healing properties of such amplifiers. That is, the subsequent erbium-doped optical amplifiers will be operating in a state of gain saturation in which a decrease in optical input power is compensated by increased amplifier gain.

FIG. 4 shows the spectral output from a typical Raman booster amplifier designed to have negative slope so that when such a signal is subsequently inserted into an erbium-doped optical amplifier, the output is nearly at the design level and has minimal gain tilt. FIG. 5 shows the spectral output from the first erbium-doped optical amplifier and FIG. 6 shows the output from the second erbium-doped optical amplifier. Clearly the flat gain shape of the signals has been restored and the erbium-doped optical amplifiers quickly restore the signal level to its design point.

The gain shape of Raman preamplifier supplying gain to transmission span 210ₙ₊₁ serving as a preamplifier is less important than the gain shape of the Raman booster amplifier because the preamplifier is located at the end of the system. Thus the pump wavelengths and gain shape for the preamplifier should be selected to optimize the optical signal-to-noise ratio over the whole range of channel frequencies.

The Raman gain supplied by the Raman preamplifier is sufficient to compensate for a large portion of the excess loss in transmission span 240ₙ₊₁ so that the signal arrives at the receiver terminal with all but possibly about 10 dB of design power. One advantage arising from the use of the Raman preamplifier is that its effective noise figure is much less than for erbium-doped optical amplifiers due to the distributed nature of the Raman amplification process. A shore-based counter-propagating pump at the receiver terminal 300 pumps the Raman amplifier 210ₙ. In this case, the Raman amplification process is less saturated than for the forward-pumped booster amplifier since the signal levels have dropped significantly by the time they reach the portion of the transmission fiber at the receiver end where the pump power is high. Therefore, high gains are achievable. In this case, the practical limit on Raman gain is constrained by double Rayleigh backscattering that causes high noise penalties for higher gains. Practically, the preamplifier can provide gains of 15-20 dB for 125-150 km spans, with very low effective noise figures.

Referring again to FIG. 1, an erbium-doped optical amplifier 360 is located in the receiver terminal between the coupler 350 that supplies the Raman pump energy and the WDM 330. The erbium-doped optical amplifier 360 supplies any additional gain needed by the signal before it traverses the relatively lossy WDM 330 to reach the receiver. Since the signal typically needs about 25-30 dB of net gain to counterbalance the loss in the transmission span 240n+1, and the Raman preamplifier can only supply about 15 dB of gain, the erbium doped optical amplifier needs to supply about 10 dB of gain.

Although various embodiments are specifically illustrated and described herein, it will be appreciated that modifications and variations of the present invention are covered by the above teachings and are within the purview of the appended claims without departing from the spirit and intended scope of the invention. For example, while optical amplifiers 210₁-210ₙ depicted in FIG. 1 have been described as repeater-based rare-earth doped optical amplifiers, the present invention also encompasses repeater-based optical amplifiers 210₁-210ₙ of any type, including, but not limited to repeater-based Raman optical amplifiers.

1. In an optical communication system that includes a transmitting terminal, a receiving terminal, and an optical transmission path optically coupling the transmitting and receiving terminals and having at least one rare-earth doped optical amplifier therein, a second optical amplifier comprising:
a first portion of the optical transmission path having a first end coupled to the transmitting terminal and a second end coupled to a first of said at least one rare-earth doped optical amplifier; and
a pump source providing pump energy to said first portion of the optical transmission path at one or more wavelengths less than a signal wavelength to provide Raman gain in the first portion at the signal wavelength.

2. In the optical communication system of claim 1, a third optical amplifier comprising:
a second portion of the optical transmission path having a first end coupled to the receiving terminal and a second end coupled to one of said at least one rare-earth doped optical amplifier; and
a second pump source providing pump energy to said second portion of the optical transmission path at one or more wavelengths less than a signal wavelength to provide Raman gain in the second portion at the signal wavelength.

3. In the optical communication system of claim 1, wherein said pump source provides Raman gain having a gain profile over a signal waveband with a positive gain tilt.

4. In the optical communication system of claim 1, wherein the Raman gain is less than that required to supply a signal saturating the first rare-earth doped optical amplifier.

5. In the optical communication system of claim 1, wherein said at least one rare-earth doped optical amplifier comprises a plurality of rare-earth doped optical amplifiers spaced apart from one another along the transmission path by a given distance, said given distance being less than a length of said first portion of the transmission path in which Raman gain is provided.

6. In the optical communication system of claim 1, wherein the pump source is arranged to provide pump energy co-propagating with a signal.

7. In the optical communication system of claim 6, wherein the pump source is co-located with the transmitting terminal.

8. In the optical communication system of claim 2, wherein the second pump source is arranged to provide pump energy counter-propagating with the signal.

9. In the optical communication system of claim 8, wherein the second pump source is co-located with the receiving terminal.

10. A method of transmitting an information-bearing optical signal along an optical communication system that includes a transmitting terminal, a receiving terminal, and an optical transmission path optically coupling the transmitting and receiving terminals and having at least one rare-earth doped optical amplifier therein, said method comprising the steps of:
a. receiving the information-bearing optical signal from the transmitting terminal;
b. supplying Raman gain to the optical signal in a first portion of the optical transmission path; and
c. subsequent to step (b), forwarding the optical signal to a first of said at least one rare-earth doped optical amplifier.

11. The method of claim 10, further comprising the steps of:
d. receiving the information-bearing optical signal from one of said at least one rare-earth doped optical amplifier;
e. supplying Raman gain to the optical signal received in step (d); and
f. subsequent to step (e), forwarding the optical signal to the receiving terminal.

12. The method of claim 10 wherein the step of supplying gain includes the step of supplying Raman gain having a gain profile with a positive gain tilt over a signal waveband.

13. The method of claim 10 wherein the Raman gain is less than that required to supply a signal saturating the first rare-earth doped optical amplifier.

14. The method of claim 10, wherein said at least one rare-earth doped optical amplifier comprises a plurality of rare-earth doped optical amplifiers spaced apart from one another along the transmission path by a given distance, said given distance being less than a distance along the transmission path between the transmitting terminal and a length of said first portion of the transmission path in which Raman gain is provided.

15. The method of claim 10, wherein the step of supplying Raman gain includes the step of supplying pump energy co-propagating with the signal.

16. The method of claim 15, wherein the pump energy is supplied from the transmitting terminal.

17. The method of claim 11, wherein the step of supplying Raman gain to the optical signal received in step (d) includes the step of supplying pump energy counter-propagating with the signal.

18. The method of claim 17, wherein the counter-propagating pump is supplied from the receiving terminal.

19. The method of claim 10 further comprising the step of increasing the Raman gain supplied to the optical signal to compensate for an increase in attenuation in the optical transmission path.

20. The method of claim 19 wherein the increase in attenuation of the optical transmission path arises from repair of a cable failure.

21. In an optical communication system that includes a transmitting terminal, a receiving terminal, and an optical transmission path optically coupling the transmitting and receiving terminals and having a plurality of optical amplifiers spaced apart from one another along the transmission path by a given distance, a Raman optical amplifier comprising:
a first portion of the optical transmission path having a first end coupled to the transmitting terminal and a second end coupled to a first of the plurality of optical amplifiers; and
a pump source providing pump energy to said first portion of the optical transmission path at one or more wavelengths less than a signal wavelength to provide Raman gain in the first portion at the signal wavelength, said given distance being less than a length of said first portion of the transmission path in which Raman gain is provided.

22. In the optical communication system of claim 21, a second Raman optical amplifier comprising:
a second portion of the optical transmission path having a first end coupled to the receiving terminal and a second end coupled to one of the plurality of optical amplifiers; and
a second pump source providing pump energy to said second portion of the optical transmission path at one or more wavelengths less than a signal wavelength to provide Raman gain in the second portion at the signal wavelength.

23. In the optical communication system of claim 21, wherein said pump source provides Raman gain having a gain profile over a signal waveband with a positive gain tilt.

24. In the optical communication system of claim 21, wherein the Raman gain is less than that required to supply a signal saturating the first optical amplifier.

25. In the optical communication system of claim 21, wherein the plurality of optical amplifiers is a plurality of rare-earth doped optical amplifiers.

26. In the optical communication system of claim 23, wherein the plurality of optical amplifiers is a plurality of rare-earth doped optical amplifiers.

27. In the optical communication system of claim 24, wherein the plurality of optical amplifiers is a plurality of rare-earth doped optical amplifiers.

28. In the optical communication system of claim 25, wherein the rare-earth doped optical amplifiers are erbium-doped optical amplifiers.

29. In the optical communication system of claim 26, wherein the rare-earth doped optical amplifiers are erbium-doped optical amplifiers.

30. In the optical communication system of claim 27, wherein the rare-earth doped optical amplifiers are erbium-doped optical amplifiers.

31. In the optical communication system of claim 22, wherein the plurality of optical amplifiers are a plurality of Raman optical amplifiers.

32. In the optical communication system of claim 22, wherein the pump source is arranged to provide pump energy co-propagating with a signal.

33. In the optical communication system of claim 32, wherein the pump source is co-located with the transmitting terminal.

34. In the optical communication system of claim 22, wherein the second pump source is arranged to provide pump energy counter-propagating with the signal.

35. In the optical communication system of claim 34, wherein the second pump source is co-located with the receiving terminal.

36. A method of transmitting an information-bearing optical signal along an optical communication system that includes a transmitting terminal, a receiving terminal, and an optical transmission path optically coupling the transmitting and receiving terminals and having a plurality of repeater-based optical amplifiers spaced apart from one another along the transmission path by a given distance, said method comprising the steps of:
a. receiving the information-bearing optical signal from the transmitting terminal;
b. supplying Raman gain to the optical signal in a first portion of the optical transmission path; and
c. subsequent to step (b), forwarding the optical signal to a first of said plurality of repeater-based optical amplifiers, wherein said given distance is less than a distance along the transmission path between the transmitting terminal and a length of said first portion of the transmission path in which Raman gain is provided.

37. The method of claim 36, further comprising the steps of:
d. receiving the information-bearing optical signal from one of said plurality of optical amplifiers;
e. supplying Raman gain to the optical signal received in step (d); and
f. subsequent to step (e), forwarding the optical signal to the receiving terminal.

38. The method of claim 36 wherein the step of supplying gain includes the step of supplying Raman gain having a gain profile with a positive gain tilt over a signal waveband.

39. The method of claim 36 wherein the Raman gain is less than that required to supply a signal saturating the first optical amplifier.

40. The method of claim 36, wherein the step of supplying Raman gain includes the step of supplying pump energy co-propagating with the signal.

41. The method of claim 40, wherein the pump energy is supplied from the transmitting terminal.

42. The method of claim 37, wherein the step of supplying Raman gain to the optical signal received in step (d) includes the step of supplying pump energy counter-propagating with the signal.

43. The method of claim 42, wherein the counter-propagating pump is supplied from the receiving terminal.

44. The method of claim 36 further comprising the step of increasing the Raman gain supplied to the optical signal to compensate for an increase in attenuation in the optical transmission path.

45. The method of claim 44 wherein the increase in attenuation of the optical transmission path arises from repair of a cable failure.

46. The method of claim 36, wherein the plurality of repeater-based optical amplifiers is a plurality of rare-earth doped optical amplifiers.

47. The method of claim 37, wherein the plurality of repeater-based optical amplifiers is a plurality of rare-earth doped optical amplifiers.

48. The method of claim 46, wherein the rare-earth doped optical amplifiers are erbium-doped optical amplifiers.

49. The method of claim 47, wherein the rare-earth doped optical amplifiers are erbium-doped optical amplifiers.

50. An optical communication system, comprising:
a transmitting terminal;
a receiving terminal;
an optical transmission path optically coupling the transmitting and receiving terminals, said optical transmission path having at least one rare-earth doped optical amplifier therein;
a second optical amplifier that includes:
a first portion of the optical transmission path having a first end coupled to the transmitting terminal and a second end coupled to a first of said at least one rare-earth doped optical amplifier; and
a pump source providing pump energy to said first portion of the optical transmission path at one or more wavelengths less than a signal wavelength to provide Raman gain in the first portion at the signal wavelength.

51. The optical communication system of claim 50 further comprising a third optical amplifier comprising:
a second portion of the optical transmission path having a first end coupled to the receiving terminal and a second end coupled to one of said at least one rare-earth doped optical amplifier; and
a second pump source providing pump energy to said second portion of the optical transmission path at one or more wavelengths less than a signal wavelength to provide Raman gain in the second portion at the signal wavelength.

52. The optical communication system of claim 50, wherein said pump source provides Raman gain having a gain profile over a signal waveband with a positive gain tilt.

53. The optical communication system of claim 50, wherein the Raman gain is less than that required to supply a signal saturating the first rare-earth doped optical amplifier.

54. The optical communication system of claim 50, wherein said at least one rare-earth doped optical amplifier comprises a plurality of rare-earth doped optical amplifiers spaced apart from one another along the transmission path by a given distance, said given distance being less than a length of said first portion of the transmission path in which Raman gain is provided.

55. The optical communication system of claim 50, wherein the pump source is arranged to provide pump energy co-propagating with a signal.

56. The optical communication system of claim 55, wherein the pump source is co-located with the transmitting terminal.

57. The optical communication system of claim 51, wherein the second pump source is arranged to provide pump energy counter-propagating with the signal.

58. The optical communication system of claim 57, wherein the second pump source is co-located with the receiving terminal.

59. In the optical communication system of claim 1, wherein said at least one rare-earth doped optical amplifier comprises at least three rare-earth doped optical amplifiers spaced apart from one another along the transmission path by specifiable distances, said specifiable distances having an average value that is less than a length of said first portion of the transmission path in which Raman gain is provided.

60. In the optical communication system of claim 1, wherein said at least one rare-earth doped optical amplifier comprises at least four rare-earth doped optical amplifiers spaced apart from one another along the transmission path by specifiable distances, wherein a majority of said specifiable distances are less than a length of said first portion of the transmission path in which Raman gain is provided.

61. In the optical communication system of claim 1, wherein said at least one rare-earth doped optical amplifier comprises a plurality of rare-earth doped optical amplifiers spaced apart from one another along the transmission path by a first transmission span, said transmission span having an optical loss at the signal wavelength that is less than an optical loss at the signal wavelength arising in said first portion of the transmission path in which Raman gain is provided.
